(19) United States
(12) Patent Application Publication
(10) Pub. No.: US 2026/0145677 A1
(43) Pub. Date: May 28, 2026

(54) VEHICLE AND METHOD FOR CONTROLLING THE SAME

(71) Applicants: Hyundai Motor Company, Seoul (KR); Kia Corporation, Seoul (KR)

(72) Inventors: Chi Hong PARK, Hwaseong-Si (KR); In Ho KIM, Hwaseong-Si (KR)

(21) Appl. No.: 19/363,138

(22) Filed: Oct. 20, 2025

(30) Foreign Application Priority Data
Nov. 22, 2024 (KR) 10-2024-0167999

(51) Int. Cl. B60W 30/17; B60W 50/14

(52) U.S. Cl. CPC B60W 30/17; B60W 50/14; B60W 2540/225; B60W 2554/4041; B60W 2720/10

(57) ABSTRACT

A vehicle and a method for controlling the same are disclosed. The vehicle includes a sensor unit, and a control circuit configured to stop the vehicle according to inter-vehicle distance control with respect to a preceding vehicle detected through the sensor unit, and control automatic restart of the vehicle based on at least one of a start point in time after stopping of the preceding vehicle and a state of a driver of the vehicle.

### CROSS-REFERENCE TO RELATED APPLICATION

This application claims priority to and the benefit of Korean Patent Application No. 10-2024-0167999, filed on November 22, 2024, the disclosure of which is incorporated herein by reference in its entirety.

### FIELD

Various examples of the present disclosure relate to technology related to automatic restart after stopping in a vehicle system.

### BACKGROUND

With the recent introduction of a driving assistance or autonomous driving function of a vehicle system, aspects described herein relate to a function of automatically decelerating or accelerating according to an inter-vehicle distance.

This technology may be currently provided in a vehicle under a concept such as smart cruise control (SCC), and a function of decreasing a speed when a distance to a preceding vehicle decreases and increasing the speed according to a speed set by a driver when the distance to the preceding vehicle increases is described herein.

Additionally, with SCC, a follow-up function, or the like, a driver’s vehicle may stop when a preceding vehicle decelerates or stops, and may automatically restart when the preceding vehicle starts again within a predetermined time.

However, when the vehicle stops for a certain period of time or longer, the driver must press an accelerator pedal or a specific button to restart automatic control in the vehicle, and therefore there may be a problem that the driver must make an inconvenient input in sections in which traffic congestion or the like occurs frequently.

### SUMMARY

The present disclosure has been made to solve the aforementioned problems, and may be directed to extending an automatic restart maintenance time of a vehicle according to a start point in time after stopping of a preceding vehicle and a state of a driver of the vehicle, and controlling an automatic restart state differently.

The problems to be solved by the present disclosure are not limited to the problems mentioned above, and other problems that have not been mentioned may be clearly understood by those skilled in the art from the description below.

According to an aspect of the present disclosure, there may be provided a vehicle including a sensor unit, and a control device configured to stop the vehicle according to inter-vehicle distance control with respect to a preceding vehicle detected through the sensor unit, and control automatic restart of the vehicle based on at least one of a start point in time after stopping of the preceding vehicle or a state of a driver of the vehicle.

The control device may be configured to control a driving state of the vehicle differently when the vehicle automatically restarts.

The control device may be configured to determine whether at least one of a first condition or a second condition related to the driver state of the vehicle is satisfied when the preceding vehicle starts within a first point in time after stopping, and automatically restart the vehicle in a first state when both the first condition and the second condition are satisfied.

The control device may be configured to automatically restart the vehicle in a second state when any one of the first condition and the second condition is satisfied, and the second state may be a state in which at least one of a restart acceleration or a restart speed may be set lower than the first state.

The control device may be configured to automatically restart the vehicle in a third state when the first condition and the second condition are not both satisfied, and the third state may be a state in which at least one of a restart acceleration or a restart speed may be set lower than the second state.

The control device may be configured to confirm whether the driver looks forward through the sensor unit when the preceding vehicle starts within a second point in time after the first point in time, and restart the vehicle in the second state when the driver looks forward, and the second state may be a state in which at least one of a restart acceleration or a restart speed may be set lower than the first state.

The vehicle may further include an input/output interface, the control device may be configured to output an eyes-on warning notification through the input/output interface when the driver does not look forward, and/or automatically restart the vehicle in the third state when the driver looks forward within the predetermined time after outputting the eyes-on warning notification, and/or the third state may be a state in which at least one of a restart acceleration or a restart speed may be set lower than the second state.

The vehicle may further include an input/output interface, and the control device may be configured to output a confirmation notification for automatic restart to the driver through the input/output interface when the preceding vehicle starts after the second point in time, and/or automatically restart the vehicle in the third state when a confirmation response from the driver is received within a predetermined time.

The control device may be configured to output at least one of a visual notification, a tactile notification, or an auditory notification through the input/output interface when the confirmation response from the driver is not received within the predetermined time.

The control device may be configured to release vehicle control in a system after the notification.

A method for controlling automatic restart after stopping of a vehicle may be provided, and the method may include stopping a vehicle according to inter-vehicle distance control with respect to a preceding vehicle, and controlling the automatic restart of the vehicle based on at least one of a start point in time after stopping of the preceding vehicle or a state of a driver of the vehicle.

The controlling of automatic restart of the vehicle may include controlling a driving state of the vehicle differently when the vehicle automatically restarts.

The controlling of the driving state of the vehicle differently when the vehicle automatically restarts may include determining whether at least one of a first condition or a second condition related to the driver state of the vehicle is satisfied when the preceding vehicle starts within a first point in time after stopping, and automatically restarting the vehicle in a first state when both the first condition and the second condition are satisfied.

Aspects described herein may further include automatically restarting the vehicle in a second state when any one of the first condition and the second condition may be satisfied, wherein the second state may be a state in which at least one of a restart acceleration or a restart speed may be set lower than the first state.

Additionally, aspects described herein may relate to automatically restarting the vehicle in a third state when the first condition and the second condition are not both satisfied, wherein the third state may be a state in which at least one of a restart acceleration or a restart speed may be set lower than the second state.

Aspects described herein may further include confirming whether the driver looks forward when the preceding vehicle starts within a second point in time after the first point in time, and automatically restarting the vehicle in a second state when the driver looks forward, wherein the second state may be a state in which at least one of a restart acceleration or a restart speed may be set lower than the first state.

Aspects described herein may further include outputting an eyes-on warning notification when the driver does not look forward, and automatically restarting the vehicle in the third state when the driver looks forward within the predetermined time after outputting the eyes-on warning notification, wherein the third state may be a state in which at least one of a restart acceleration or a restart speed may be set lower than the second state.

Aspects described herein may further include outputting a confirmation notification for automatic restart to the driver when the preceding vehicle starts after the second point in time, and/or automatically restarting the vehicle in the third state when a confirmation response from the driver is received within a predetermined time, wherein the third state may be a state in which at least one of a restart acceleration or a restart speed may be set lower than the second state.

Aspects described herein may further include outputting at least one of a visual notification, a tactile notification, or an auditory notification when a confirmation response from the driver may be not received within the predetermined time.

Aspects described herein may further include releasing vehicle control in a system after the notification.

### BRIEF DESCRIPTION OF THE DRAWINGS

The above and other objects, features and advantages of the present disclosure will become more apparent to those of ordinary skill in the art by describing exemplary examples thereof in detail with reference to the accompanying drawings, in which:

FIG. 1 is a configuration diagram of a vehicle;

FIG. 2 is a flowchart illustrating an automatic restart control operation according to inter-vehicle distance control;

FIG. 3 is an illustrative diagram of the inter-vehicle distance control;

FIG. 4 is an illustrative diagram of a screen for monitoring a driver state; and

FIG. 5 is a flowchart of an automatic restart control operation according to inter-vehicle distance control.

FIG. 6 is a flowchart of an automatic restart control operation according to inter-vehicle distance control.

FIG. 7 is a flowchart of an automatic restart control operation according to inter-vehicle distance control.

FIG. 8 is a flowchart of an automatic restart control operation according to inter-vehicle distance control.

### DETAILED DESCRIPTION OF EXEMPLARY EXAMPLES

Hereinafter, examples of the present disclosure will be described in detail with reference to the accompanying drawings.

However, the technical idea of the present disclosure may be not limited to the few examples that will be described, but may be implemented in various different forms, and one or more of the components in the examples may be selectively combined or substituted and used within the scope of the technical idea of the present disclosure.

In addition, the terms used in the examples of the present disclosure are intended to describe the examples and are not intended to limit the present disclosure.

In the present specification, a singular form may include a plural form unless the context clearly indicates otherwise, and when “at least one (or one or more) of A, B, or C” may be described, this may include one or more of all combinations of A, B, and C.

In addition, terms such as “first,” “second,” “A,” “B,” “(a),” and “(b)” may be used to describe components in the examples of the present disclosure.

The term “module” or “unit” used in the specification means a software and/or hardware component, and the “module” or “unit” performs certain operations/functions/roles. However, the “module” or “unit” is not construed as being limited to software or hardware. The “module” or “unit” may be configured to be in an addressable storage medium or to execute one or more processors. Therefore, as an example, the “module” or “unit” may include at least one of components such as software components, object-oriented software components, class components, and task components, processes, functions, attributes, procedures, sub-routines, segments of program codes, drivers, firmware, micro-codes, circuits, data, databases, data structures, tables, arrays, or variables. Functions provided in the components, “modules” or “units” may be combined into a smaller number of components, “modules” or “units” or further divided into additional components, “modules” or “units”.

In the present disclosure, the “module,” “device,” or “unit,” etc. may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. For example, the “processor” may refer to a combination of processing devices such as a combination of a DSP and a microprocessor, a combination of a plurality of microprocessors, a combination of one or more microprocessors combined with a DSP core, or any other such combination. Moreover, the “memory” should be widely construed to include any electronic component capable of storing electronic information. The “memory” may refer to various types of processor-readable medium such as a random access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage device, and registers. When the processor can read information from a memory and/or record the information in the memory, the memory may be in a state of electronic communication with a processor. Memory integrated into a processor is in a state of electronic communication with the processor.

The one or more features described herein may be provided as a computer program stored in a computer-readable recording medium in order to be executed on a computer. The medium may either continuously store a computer-executable program or temporarily store the program for execution or download. Furthermore, the medium may be a variety of recording or storage means in the form of a single hardware device or multiple combined hardware devices, and is not limited to media directly connected to some computer system but may also be distributed across a network. Examples of such media include magnetic media such as a hard disk, a floppy disk, or a magnetic tape, optical recording media such as a CD-ROM or a DVD, magneto-optical media such as a floptical disk, and a ROM, RAM, or flash memory, among others, configured to store program instructions. Additional examples of such media include media or storage media that are managed by an app store that distributes applications or by various other sites or servers that provide or distribute software.

In a hardware implementation, processing units used for performing the techniques may be implemented within one or more ASICs, DSPs, digital signal processing devices, programmable logic devices, field-programmable gate arrays, processors, controllers, microcontrollers, microprocessors, electronic devices, or computers or combinations thereof designed to perform the functions described in the present disclosure.

These terms are only intended to distinguish the component from other components, and do not limit the nature, order, or sequence of the component.

When a component may be described as being “connected,” “coupled,” or “joined” to another component, this may include not only a case where the component may be directly connected, coupled, or joined to the other component, but also a case where the component may be “connected,” “coupled,” or “joined” to the other component by still another component between the component and the other component.

Further, when one component may be described as being formed or disposed “on or under” another component, the term “on or under” includes not only a case in which two components are in direct contact with each other, but also a case in which one or more other components are formed or disposed between the two components. In addition, when the term “on or under” may be expressed, this may mean not only an upward direction but also a downward direction with respect to one component.

In various flowcharts of the present disclosure, at least some steps may be omitted or the order of the steps may be changed, and at least some of the various examples of the present disclosure may be performed at a specific point in time in each step of the flowchart. Operations in the various flowcharts of the present disclosure may be performed by at least one of a control device 100, a processor 130, and a vehicle 1. Further, overlapping content in the drawings of the present disclosure may be omitted.

A “vehicle” mentioned in the present document may be a vehicle that a driver has boarded, and a “preceding vehicle” may be construed as another vehicle located ahead.

Hereinafter, the examples will be described in detail with reference to the accompanying drawings, the same or corresponding components will be denoted by the same reference numbers throughout the drawings, and redundant description thereof will be omitted.

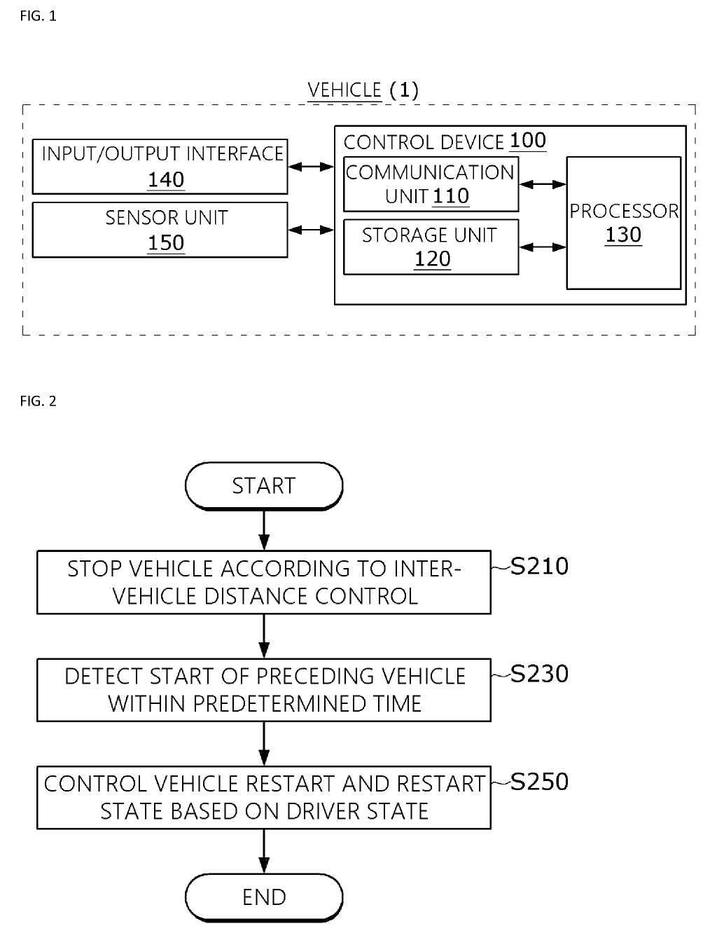

FIG. 1 may be a configuration diagram of the vehicle 1 according to an example.

The vehicle 1 may include the control device 100, a communication unit 110, a storage unit 120, the processor 130, an input/output interface 140, and a sensor unit 150. Each of the components of FIG. 1 may be implemented inside the vehicle.

The vehicle 1 may include an autonomous driving or driving assistance function. The autonomous driving function may include a function capable of longitudinal or lateral driving control based on a distance between a vehicle and a preceding vehicle. For example, the autonomous driving or driving assistance function may include a smart cruise control (SCC) function, a vehicle follow-up function, and the like, but may be not limited thereto.

The control device 100 may be a device or program that controls the vehicle 1 based on the distance between the vehicle and the preceding vehicle, and controls an automatic restart state of the vehicle 1 based on at least one of a start point in time after the preceding vehicle stops or a state of a driver of the vehicle 1.

The control device 100 may be formed integrally with internal components of the vehicle, and/or may be implemented as a separate device and connected to the internal components of the vehicle by a separate connection means. The control device 100 may be illustrated as including the communication unit 110, the storage unit 120, and the processor 130, but may include other components (for example, the input/output interface 140 and the sensor unit 150) of the vehicle 1.

The communication unit 110 may perform communication with a user terminal, another vehicle, or an external server. The communication unit 110 may perform short-range communication, GPS signal reception, V2X communication, optical communication, broadcast transmission and reception, and intelligent transport systems (ITS) communication functions. The communication unit 110 may support short range communication using at least one of Bluetooth, radio frequency identification (RFID), Infrared Data Association (IrDA), ultra wideband (UWB), ZigBee, near field communication (NFC), Wi-Fi, Wi-Fi Direct, and wireless USB technologies. The communication unit 110 may include a mobile communication module using a mobile communication network and a wireless Internet module for access to wireless Internet.

The storage unit 120 may include instructions for controlling the vehicle 1 based on the distance between the vehicle and the preceding vehicle, and controlling an automatic restart state of the vehicle 1 based on at least one of a start point in time after the preceding vehicle stops or a state of a driver of the vehicle 1.

The storage unit 120 may include a memory. The storage unit 120 may be included inside the processor 130 or the control device 100, or may be a separate memory. The storage unit 120 may be configured as a combination of a non-volatile memory such as a hard disk drive, a flash memory, an electrically erasable programmable read-only memory (EEPROM), a static random access memory (SRAM), a ferroelectric RAM (FRAM), a phase-change RAM (PRAM), or a magnetic RAM (MRAM), and/or a volatile memory such as a dynamic random access memory (DRAM), a synchronous dynamic random access memory (SDRAM), or a double data rate-SDRAM (DDR-SDRAM).

The processor 130 may be electrically or operatively connected to the communication unit 110, the storage unit 120, the input/output interface 140, the sensor unit 150, and various internal components of the vehicle 1, may electrically control each component, and may be an electrical circuit that executes commands of software, thereby performing various types of data processing and calculations to be described below.

The processor 130 can process signals transmitted between the respective components of the vehicle 1 and perform overall control so that each component can perform its function normally. The processor 130 may be implemented in the form of hardware, in the form of software, or in the form of a combination of hardware and software. Further, the control device 100 may include at least one processor 130.

The input/output interface 140 may include an input means for receiving a control command from a user, and an output means for outputting, for example, an operation status and results of the control device 100. Here, the input means may include physical keys (for example, physical buttons), and soft keys implemented on a touch display.

The output means may include a display, and may further include an audio module such as a voice output means (for example, a speaker), and/or a haptic module that generates vibrations. In this case, when a touch sensor such as a touch film, a touch sheet, or a touch pad may be provided in the display, the display may operate as a touch screen, and the input means and the output means may be implemented in an integrated form.

The input/output interface 140 may be implemented as physical buttons, a display, a head-up display (HUD), a cluster, an audio video navigation (AVN), a human machine interface (HMI), a user setting menu (USM), or the like. Also, the display may be included in a rearview mirror or a side mirror.

For example, the user may request an operation and a display related to automatic restart control according to an inter-vehicle distance and a user state through a physical button of a cluster or a display of the AVN serving as the input means. In addition, the vehicle 1 may receive an input or output a screen through a display of a console located in a second row or a third row of the vehicle, or a display of an application implemented in a user terminal.

The input/output interface 140 may include a button for driver confirmation in relation to automatic restart. The button for driver confirmation may be located in a steering wheel area, but may be not limited thereto.

The sensor unit 150 may include at least one of a radio detection and ranging (RADAR), a light imaging detection and ranging (LiDAR), a fingerprint recognition sensor, a retina recognition sensor, an iris recognition sensor, a camera, a steering wheel detection sensor, a pressure sensor, a position sensor (for example, GPS), an ultrasonic sensor, a heart rate sensor, a light sensor, a pressure sensor, a motion sensor, a seating sensor, an accelerator pedal sensor, a deceleration pedal sensor, and an infrared sensor. The camera may include an external camera for monitoring the outside of the vehicle and an internal camera for detecting an object such as the driver inside the vehicle.

The sensor unit 150 may calculate the presence of a preceding vehicle and a distance between the preceding vehicle and the vehicle 1 through a configuration such as an external camera, radar, and the like. This makes control according to an inter-vehicle distance possible. Further, the sensor unit 150 may transmit information on the presence/absence of a stopped preceding vehicle to the control device 100.

The sensor unit 150 may include a driver monitoring sensor (ICC) device that can recognize whether the driver looks forward. The driver monitoring sensor device may include at least one of at least one internal camera, a steering wheel detection sensor, a pressure sensor, an accelerator pedal sensor, or a deceleration pedal sensor. The internal camera may be installed in an area adjacent to a steering wheel or a rearview mirror, but a specific location, number, and shape thereof are not limited.

The camera or the driver monitoring sensor has been described as being included in the sensor unit 150, but may be not limited thereto and may be implemented as a separate configuration from the sensor unit 150.

One or more features described herein may be used to control at least one autonomous driving control operation. An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein.

One or more features associated with autonomous driving control may be activated based on configured autonomous driving control setting(s) (e.g., based on at least one of: an autonomous driving classification, a selection of an autonomous driving level for a vehicle, etc.). Based on one or more features (e.g., the control of automatic restart) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., the control of automatic restart) described herein. One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., the control of automatic restart) described herein.

Minimum risk maneuver (MRM) operation(s) may also be controlled, for example, based on one or more features (e.g., the control of automatic restart) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., the control of automatic restart) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane. The driving control apparatus may identify or determine a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., the control of automatic restart) described herein. An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, etc.).

An autonomous driving level and/or autonomous driving activation/deactivation may also be controlled, for example, based on one or more features (e.g., the control of automatic restart) described herein. A driving control apparatus may perform an autonomous driving level control (e.g., a change of an autonomous driving level, a change of a required user attentiveness, etc.) or cause deactivation of an autonomous driving operation. For example, by changing the required user attentiveness, the driver may be required to place his/her hands on the driving wheel more often (e.g., at least once in a threshold time period, such as five second, 30 seconds, 1 minute, etc.). By changing the required user attentiveness, the driver may be required to look ahead more often (e.g., at least once in a threshold time period, such as five second, 30 seconds, 1 minute, etc.). By changing the autonomous driving level, one or more video contents may not be displayed on a display of the vehicle.

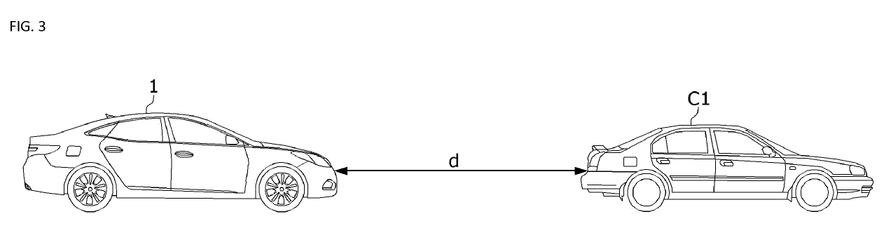

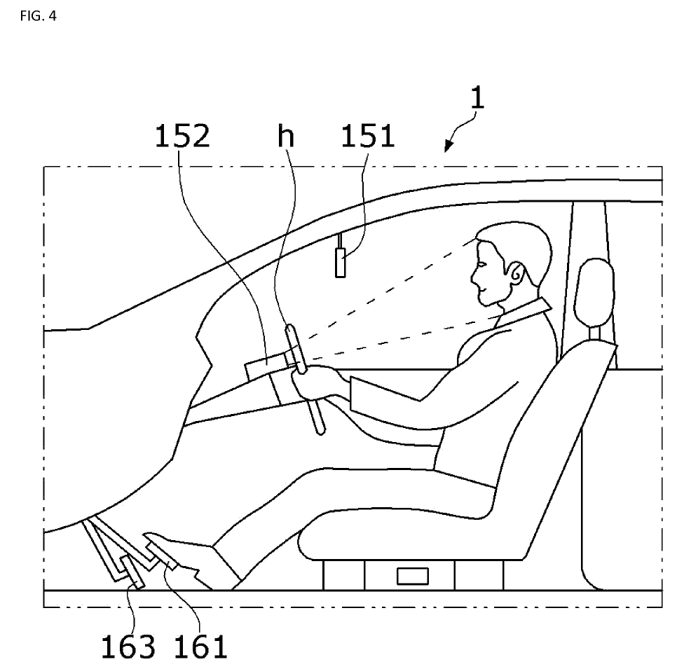

FIG. 2 is a flowchart illustrating an automatic restart control operation according to inter-vehicle distance control through the control device 100. Reference will be made to FIGS. 3 and 4 for description of FIG. 2. FIG. 3 may be an illustrative diagram of inter-vehicle distance control according to an example, and FIG. 4 may be an illustrative diagram of a screen for monitoring a driver state.

The control device 100 may stop the vehicle according to the inter-vehicle distance control (S210).

The control device 100 may automatically control longitudinal driving based on the inter-vehicle distance according to the autonomous driving or driving assistance function. The control device 100 may activate, for example, the smart cruise control (SCC) function or the vehicle follow-up function to control the driving of the vehicle 1 based on the inter-vehicle distance between the vehicle 1 and the preceding vehicle.

For example, as illustrated in FIG. 3, the vehicle 1 may refer to a state in which the inter-vehicle distance control in the vehicle system has been activated. The control device 100 may decelerate the vehicle 1 when the vehicle 1 approaches the preceding vehicle C1 within a predetermined distance d. Further, when the preceding vehicle C1 decelerates and then stops, the control device 100 may stop the vehicle 1.

Next, the control device 100 may detect the start of the preceding vehicle within a predetermined time (S230).

The control device 100 may restart the vehicle 1 according to a distance to the preceding vehicle when the vehicle 1 starts before a predetermined time has elapsed from a point in time when the vehicle 1 stops.

Automatic restart might be possible in limited conditions, such as when there may be a specific action of the driver after the predetermined time has elapsed from the point in time when the vehicle 1 stops. For example, automatic restart may be possible when a specific user state of the vehicle 1 may be confirmed at the time of restart of the preceding vehicle C1 even when the predetermined time has elapsed from the point in time when the vehicle 1 stops. Specific details of this will be described later.

Next, the control device 100 may control the automatic restart state of the vehicle 1 based on the driver state (S250).

The control device 100 may restart the vehicle 1 according to the distance to the preceding vehicle before the predetermined time has elapsed from the point in time when the vehicle 1 stops or when a specific user state may be confirmed. Further, the control device 100 may control the vehicle status at the time of restarting differently according to the condition of the user (for example, driver).

Referring to FIG. 4, the control device 100 may monitor the user state through the sensor unit 150.

According to an example, the user state may include at least one of whether the driver looks forward, an eyes-on time, an eye state, whether or not a steering wheel h may be gripped, strength of gripping the steering wheel h, a gripped area of the steering wheel h, or a pedal support state.

For example, the control device 100 may confirm whether or not the driver looks forward and the eyes-on time through at least one of a first internal camera 151 or a second internal camera 152 in the vehicle 1. Further, a state in which the driver closes the eyes for a predetermined period of time or more due to being drowsy or asleep may be detected.

The first internal camera 151 may be included in the rearview mirror or may be located in an area adjacent to the rearview mirror, and the second internal camera 152 may be included in an area adjacent to the steering wheel h.

The first internal camera 151 and the second internal camera 152 may have the same configuration, but may have different functions according to an example. For example, at least one of the first internal camera 151 or the second internal camera 152 may further include a thermal imaging function. Cameras having different configurations make it possible to efficiently recognize the overall driver state in consideration of a driver’s eyes-on state, how long the driver’s eyes have been closed, the driver’s body temperature, and the like.

The control device 100 may confirm, for example, whether the driver may be gripping the steering wheel h, with how much strength the driver may be gripping the steering wheel h, or how much of the area of the steering wheel h the driver may be gripping through the steering wheel detection sensor, in order to monitor the driver state. The control device 100 may confirm, for example, whether the area of the steering wheel h may be gripped with one hand, two hands, only some fingers, or fingers and a palm.

The steering wheel detection sensor may be included in the steering wheel h to be distributed over at least a partial area of the steering wheel h, and the steering wheel detection sensor may include a pressure sensor, a resistance sensor, a hall sensor, an ECU, a circuit module, and the like, but may be not limited thereto.

The control device 100 may monitor the driver state based on the pedal support state. The control device 100 may confirm a driver’s intention to accelerate or decelerate through a deceleration pedal sensor included in a deceleration (brake) pedal 161 and an acceleration pedal sensor included in an accelerator pedal 163.

The control device 100 may control the restart state based on the monitored user state as described above. The restart state may include, for example, a start speed or acceleration of the vehicle 1 at the time of restarting. This will be described in detail through the following drawings.

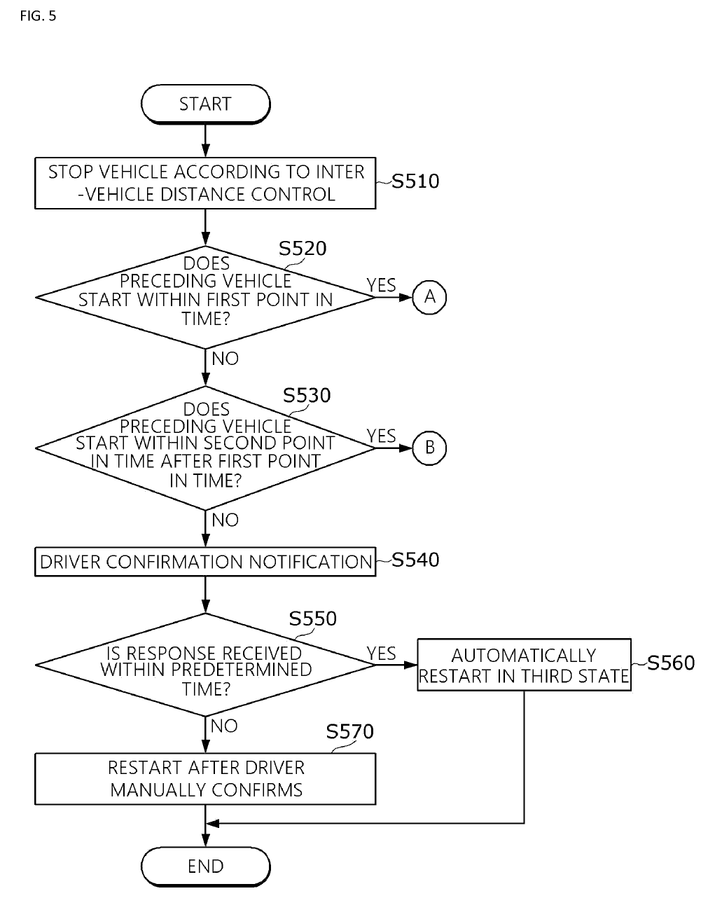

FIGS. 5 to 8 are specific flowcharts of automatic restart control operations according to inter-vehicle distance control.

The control device 100 may stop the vehicle 1 according to control of the inter-vehicle distance with respect to the preceding vehicle (S510)

Thereafter, the control device 100 may determine whether the preceding vehicle starts again within a first point in time t1 (S520).

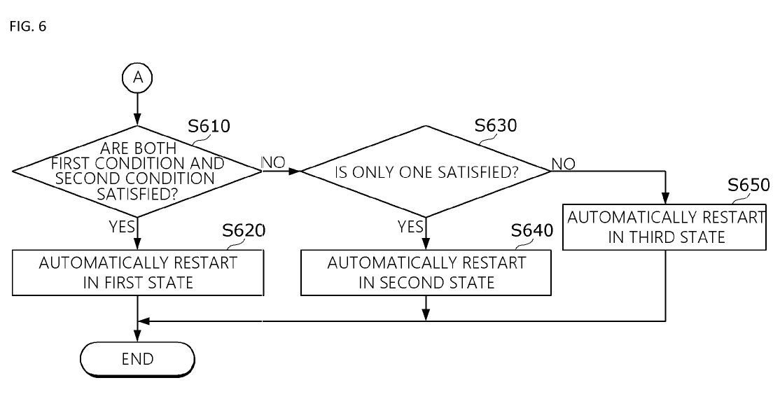

When the preceding vehicle starts within the first point in time t1 (S520: Yes), the example of the present disclosure branches to FIG. 6, and the control device 100 may determine whether a first condition and a second condition are satisfied (S610).

The first condition may be a condition related to a state of a user (for example, a driver). For example, the first condition may be a condition regarding whether or not the driver looks forward. According to an example of the present disclosure, whether or not the driver looks forward may be a factor with the highest priority at the time of determining the automatic restart.

The second condition may also be a condition related to the state of the user (for example, the driver), but may be a different condition from the first condition. For example, the second condition may be a condition in which the driver supports a deceleration (brake) pedal. For example, the second condition may be a state in which the driver does not directly apply pressure to the deceleration pedal but rests or supports his/her foot on the brake pedal. The state in which the driver supports the foot on the brake pedal may mean a case in which no pressure may be applied to the deceleration pedal or a pressure lower than a predetermined pressure may be applied. This may be because a control event such as the termination of an inter-vehicle distance control state may occur when a pressure equal to or higher than the predetermined pressure may be applied to the brake pedal. This deceleration pedal support condition may be the next most important factor after the driver’s eyes-on at the time of determining the automatic restart.

Although the first and second conditions have been described as examples according to desirable priorities, the first and second conditions can be arbitrarily set from the content related to monitoring of the user state according to various examples.

For example, each of the first condition and the second condition may be at least one of whether or not the driver looks forward, an eyes-on time, whether or not the steering wheel h may be gripped, strength of gripping the steering wheel h, a gripped area of the steering wheel h, and an acceleration or deceleration pedal support state.

When both the first condition and the second condition are satisfied (S610: Yes), the control device 100 may automatically restart the vehicle 1 in a first state (S620). For example, the control device 100 may automatically restart the vehicle 1 at a first acceleration.

When the first condition and the second condition are not both satisfied (S610: No), the control device 100 may confirm whether only one of the first condition and the second condition may be satisfied (S630).

When only one of the first condition and the second condition may be satisfied (S630: Yes), the control device 100 may automatically restart the vehicle 1 in a second state (S640). For example, the control device 100 may automatically restart the vehicle 1 at a second acceleration.

At the time of automatic restart, the second state may be a state in which the driving of the vehicle 1 may be set to be further restricted compared to the first state. That is, the second state may be a state in which at least one of a restart acceleration or a restart speed may be set lower than the first state. This may be because the second state may be an automatic restart control state when a driver’s attention may be lower than that in the first state. For example, the second acceleration included in the second state may be lower than the first acceleration included in the first state.

When the first condition and the second condition are not both satisfied (S630: No), the control device 100 may automatically restart the vehicle 1 in a third state (S650).

As described above, the third acceleration, which may be an example of the third state, may be set to be lower than the second acceleration, which may be an example of the second state.

Additionally, the state of the vehicle 1 at the time of automatic restart may be disclosed as being, for example, the acceleration, but may be not limited thereto and may include a state such as speed or driving force.

Referring back to FIG. 5, when the preceding vehicle does not start within the first point in time (S520: No), the control device 100 may determine whether the preceding vehicle starts within a second point in time t2 after the first point in time t1 (S530). This second point in time may be a time after the first point in time.

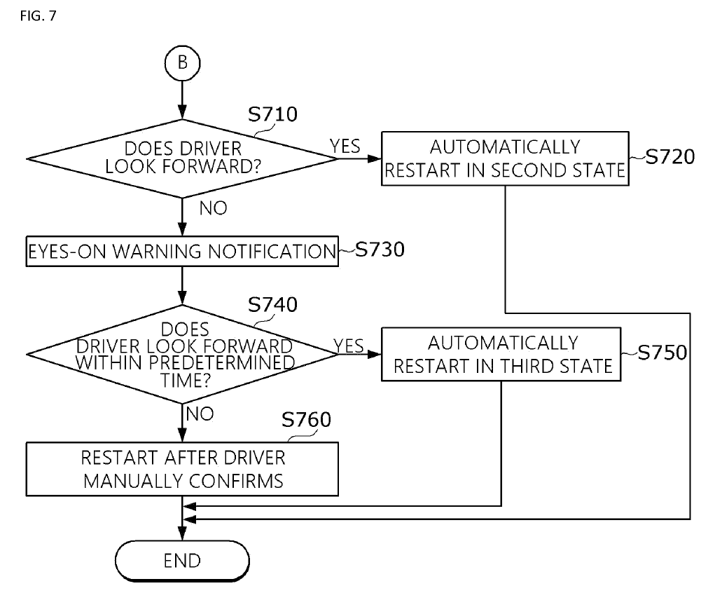

When the preceding vehicle starts within the second point in time after the first point in time (S530: Yes), the example of the present disclosure branches to FIG. 7, where the control device 100 may determine whether the driver looks forward (S710). The driver’s eyes-on may correspond to the first condition described above.

When a determination may be made that the driver looks forward (S710: Yes), the control device 100 may automatically restart the vehicle 1 in the second state (S720). Thus, when the control device 100 detects the driver’s eyes-on, the control device 100 may extend a time for automatic restart of the vehicle 1 and control the vehicle 1 so that the vehicle 1 can restart at a certain acceleration depending on whether or not the driver may be paying attention.

When a determination may be not made that the driver looks forward (S710: No), the control device 100 may output an eyes-on warning notification (S730).

For example, the control device 100 may output a request to the driver to look forward through the input/output interface 140. This request may be output through text, an image, a video, or an audio signal, but may be not limited thereto.

After the request may be output, the control device 100 may determine whether the driver looks forward within a predetermined time (S740).

When the driver looks forward within the predetermined time (S740: Yes), the control device 100 may automatically restart the vehicle 1 in the third state (S750).

When the driver does not look forward within the predetermined time (S740: No), the control device 100 may automatically restart the vehicle 1 after driver confirmation (S760). For example, the control device 100 may output a driver confirmation notification for automatic restart and confirm a user confirmation response through the input/output interface 140 or the sensor unit 150 to control automatic restart.

Referring again to FIG. 5, when the preceding vehicle starts after the second point in time t2 (S530: No), the control device 100 may output the driver confirmation notification (S540).

The driver confirmation notification may be guide information for inducing the driver’s participation so that the vehicle 1 can automatically restart. To this end, the control device 100 may display that the vehicle may be currently in a standby state for automatic restart through the input/output interface 140. This driver confirmation notification may be output in a way that may be the same as or similar to a user confirmation guide of FIG. 7 described above.

Next, the control device 100 may confirm whether a driver confirmation response may be received within a predetermined time (S550).

The driver confirmation response may be input through the accelerator pedal 163 of FIG. 4 or a specific button included in the input/output interface 140. The specific button may be, for example, a button included in the steering wheel h, but may be not limited thereto, and the specific button may also be implemented as a UI item displayed through a display.

The driver confirmation response may be made through a user gesture. For example, the driver may input the driver confirmation response through a preset interaction input (for example, hand gesture).

When the driver confirmation response may be received within the predetermined time (S550: Yes), the control device 100 may automatically restart the vehicle 1 in the third state (S560).

On the other hand, when the driver confirmation response may be not received within the predetermined time (S550: No), the control device (100) may accelerate the vehicle (1) to restart based on a manual input from the driver. (S570). In some cases, the operation shown in the present diagram may end with the vehicle 1 remaining stopped.

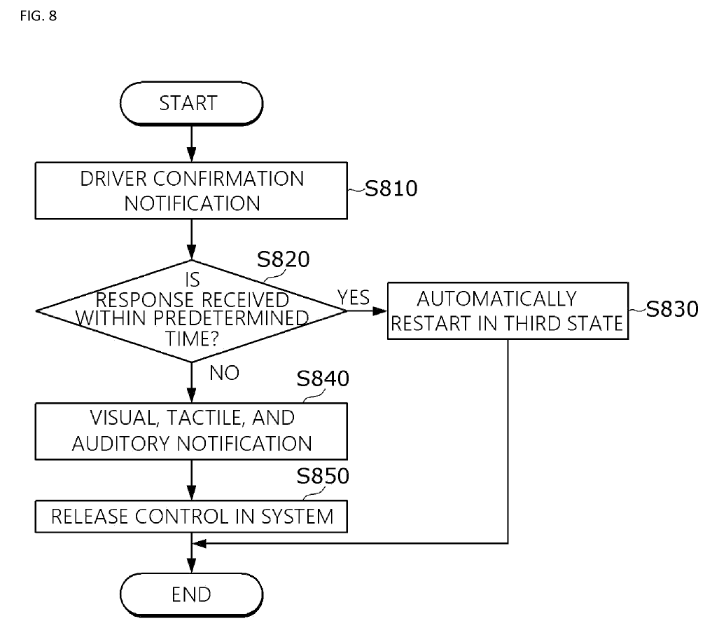

FIG. 8 may be a flowchart showing an operation of the control device 100.

FIG. 8 corresponds to the content of controlling the operations S540 to S570 of FIG. 5 in a different manner.

In FIG. 8, the control device 100 may output the driver confirmation notification (S810) and confirm whether the driver confirmation response may be received within a predetermined time (S820). When the driver confirmation response may be received within the predetermined time, the control device 100 may automatically restart the vehicle in the third state (S830). The operations S810 to S830 may be performed with the same content as operations S540 to S560 in FIG. 5 described above.

When the driver confirmation response is not received within a predetermined time (S820: No), the control device 100 may output at least one of a visual notification, an auditory notification, or a tactile notification (S840). For example, an emergency light may be turned on, or a vibration notification may be output through a haptic module. The notification in FIG. 8 may be a notification in a more advanced manner than the driver confirmation notification and the eyes-on warning notification described above. For example, a sound output in S840 may be output louder than a driver confirmation notification sound and an eyes-on warning notification sound.

Then, the control device 100 may release the control in the system (S850). For example, the control device 100 may release the autonomous driving function or the driver driving assistance function. When the driver’s attention might not be detected even after a third point in time, the control in the system may be released so that the driving control according to the inter-vehicle distance can be deactivated.

The longitudinal control has been described in relation to automatic restart driving control, but the present disclosure may be not limited thereto and lateral control may be performed together. For example, the control device 100 may control the lateral driving of the vehicle 1 based on objects on the side or a road situation at the time of the longitudinal control according to the inter-vehicle distance.

Through the above-described examples, it may be possible to enable an automatic restart function after stopping to be more conveniently used, by extending an automatic restart maintenance time of the vehicle according to a start point in time after stopping of the preceding vehicle and a vehicle driver state.

The term “unit” used in the example means a software or hardware component such as a field-programmable gate array (FPGA) or an ASIC, and a “unit” performs a certain role. However, “unit” may be not limited to software or hardware. A “unit” may be configured to reside on an addressable storage medium or may be configured to operate one or more processors. Accordingly, for example, a “unit” includes components such as software components, object-oriented software components, class components, and task components, processes, functions, attributes, procedures, subroutines, segments of program code, drivers, firmware, microcode, circuits, data, databases, data structures, tables, arrays, and variables. Functions provided in the components and the “units” may be combined into a smaller number of components and “units” or may be further separated into additional components and “units.” In addition, the components and “units” may be implemented to operate one or more CPUs in a device or a secure multimedia card.

It may be possible to enable an automatic restart function after stopping to be more conveniently used by extending an automatic restart maintenance time of the vehicle according to a start point in time after stopping of the preceding vehicle and a vehicle driver state.

The effects of the present disclosure are not limited to the effect mentioned above, and other effects that have not been mentioned may be clearly understood by those skilled in the art from the description below.

Although the present disclosure has been described above with reference to examples of the present disclosure, it will be understood by those skilled in the art that various modifications and changes can be made to the present disclosure without departing from the spirit and scope of the present disclosure set forth in the following claims.

What is claimed is:

1. A vehicle comprising:
a sensor unit; and
a control circuit configured to:
stop the vehicle according to an inter-vehicle distance control with respect to a preceding vehicle detected through the sensor unit; and
control, based on at least one of a start point in time after stopping of the preceding vehicle or a driver state of a driver of the vehicle, an automatic restart of the vehicle.

2. The vehicle of claim 1, wherein the control circuit is further configured to, based on the vehicle automatically restarting, control at least one of a restart acceleration or a restart speed of the vehicle.

3. The vehicle of claim 2, wherein the control circuit is further configured to:
determine, based on the preceding vehicle starting within a first point in time after stopping, whether at least one of a first condition or a second condition related to the driver state of the vehicle is satisfied; and
based on determining that both the first condition and the second condition are satisfied, automatically restart the vehicle in a first state.

4. The vehicle of claim 3, wherein:
the control circuit is further configured to:
automatically restart, based on determining that either the first condition or the second condition is satisfied, the vehicle in a second state, wherein the second state is a state in which at least one of a restart acceleration or a restart speed is set lower than the first state.

5. The vehicle of claim 4, wherein:
the control circuit is further configured to:
automatically restart, based on determining that the first condition and the second condition are not both satisfied, the vehicle in a third state, wherein the third state is a state in which at least one of a restart acceleration or a restart speed is set lower than the second state.

6. The vehicle of claim 3, wherein:
the control circuit is further configured to:
confirm, based on determining that the preceding vehicle started within a second point in time after the first point in time, whether the driver looks forward through the sensor unit; and
based on determining that the driver looked forward, automatically restart the vehicle in a second state, wherein the second state is a state in which at least one of a restart acceleration or a restart speed is set lower than the first state.

7. The vehicle of claim 6, wherein:
the vehicle further includes an input/output interface,
the control circuit is further configured to:
output, based on determining that the driver is not looking forward, an eyes-on warning notification through the input/output interface, and
automatically restart, based on determining that the driver looked forward within a predetermined time after outputting the eyes-on warning notification, the vehicle in a third state, wherein the third state is a state in which at least one of a restart acceleration or a restart speed is set lower than the second state.

8. The vehicle of claim 6, wherein:
the vehicle further includes an input/output interface, and
the control circuit is further configured to:
output, based on determining that the preceding vehicle started after the second point in time, a confirmation notification for automatic restart to the driver through the input/output interface; and
automatically restart, based on receiving a confirmation response from the driver within a predetermined time, the vehicle in a third state.

9. The vehicle of claim 6, wherein the control circuit is further configured to:
output, based on a confirmation response from the driver not being received within a predetermined time, at least one of a visual notification, a tactile notification, or an auditory notification through an input/output interface of the vehicle.

10. The vehicle of claim 9, wherein the control circuit is further configured to:
release vehicle control in a system after the at least one of: the visual notification, the tactile notification, or the auditory notification.

11. A method for controlling automatic restart after stopping of a vehicle, the method comprising:
stopping, by an apparatus of the vehicle, the vehicle according to inter-vehicle distance control with respect to a preceding vehicle; and
controlling, based on at least one of a start point in time after stopping of the preceding vehicle or a state of a driver of the vehicle, the automatic restart of the vehicle.

12. The method of claim 11, wherein the controlling of automatic restart of the vehicle comprises controlling, based on an automatic restart of the vehicle, at least one of:
a restart acceleration of the vehicle, or
a restart speed of the vehicle.

13. The method of claim 12, wherein:
the controlling at least one of a restart acceleration or a restart speed of the vehicle comprises:
determining, based on determining that the preceding vehicle started within a first point in time after stopping, whether at least one of a first condition or a second condition related to a driver state of the vehicle is satisfied; and
automatically restarting, based on determining that both the first condition and the second condition are satisfied, the vehicle in a first state.

14. The method of claim 13, further comprising:
automatically restarting, based on any one of the first condition and the second condition being satisfied, the vehicle in a second state, wherein
the second state is a state in which at least one of a restart acceleration or a restart speed is set lower than the first state.

15. The method of claim 14, further comprising:
automatically restarting, based on determining that the first condition and the second condition are not both satisfied, the vehicle in a third state, wherein
the third state is a state in which at least one of a restart acceleration or a restart speed is set lower than the second state.

16. The method of claim 13, further comprising:
confirming, based on determining that the preceding vehicle started within a second point in time after the first point in time, whether the driver looks forward; and
automatically restarting, based on determining that the driver looked forward, the vehicle in a second state, wherein
the second state is a state in which at least one of a restart acceleration or a restart speed is set lower than the first state.

17. The method of claim 16, further comprising:
outputting, based on determining that the driver is not looking forward, an eyes-on warning notification, and
automatically restarting, based on determining that the driver looked forward within a predetermined time after outputting the eyes-on warning notification, the vehicle in a third state, wherein
the third state is a state in which at least one of a restart acceleration or a restart speed is set lower than the second state.

18. The method of claim 16, further comprising:
outputting, based on determining that the preceding vehicle started after the second point in time, a confirmation notification for automatic restart to the driver; and
automatically restarting, based on determining that a confirmation response from the driver was received within a predetermined time, the vehicle in a third state, wherein
the third state is a state in which at least one of a restart acceleration or a restart speed is set lower than the second state.

19. The method of claim 17, further comprising:
outputting, based on determining that a confirmation response from the driver was not received within a predetermined time, at least one of a visual notification, a tactile notification, and an auditory notification.

20. A computing device of a first vehicle, the computing device comprising:
one or more processors, and
memory storing instructions that, when executed by the one or more processors, cause the first vehicle to:
receive, during driving operations of the first vehicle and from a sensor unit of the first vehicle, data indicating one or more second vehicles in an environment of the first vehicle;
cause, based the data indicating that at least one of the one or more second vehicles are within a distance threshold, the first vehicle to stop; and
cause, after the first vehicle has stopped, the first vehicle to restart based on:
a driver state of the first vehicle; and
determining that a period of time has elapsed.
